(19) United States
(12) Patent Application Publication
(10) Pub. No.: US 2013/0198790 A1
(43) Pub. Date: Aug. 1, 2013

(54) METHOD AND APPARATUS FOR ACCESSING SERVICE DISCOVERY METADATA

(71) Applicants: Truong Cong Thang, Daejeon (KR); Jung Won Kang, Daejeon (KR); Seong Jun Bae, Daejeon (KR); Sang Taick Park, Daejeon (KR); Won Ryu, Daejeon (KR)

(72) Inventors: Truong Cong Thang, Daejeon (KR); Jung Won Kang, Daejeon (KR); Seong Jun Bae, Daejeon (KR); Sang Taick Park, Daejeon (KR); Won Ryu, Daejeon (KR)

(73) Assignee: Electronics and Telecommunications Research Institute, Daejeon (KR)

(21) Appl. No.: 13/641,059

(22) PCT Filed: Apr. 12, 2011
(86) PCT No.: PCT/KR2011/002591

§ 371 Date: Dec. 26, 2012

Related U.S. Application Data
(60) Provisional application No. 61/322,943, filed on Apr. 12, 2010.
(60) Provisional application No. 61/322,945, filed on Apr. 12, 2010.
(60) Provisional application No. 61/323,436, filed on Apr. 13, 2010.

(30) Foreign Application Priority Data
Mar. 21, 2011 (KR) 10-2011-0024750

(51) Int. Cl. H04N 21/643

(52) U.S. Cl. CPC H04N 21/64322
USPC 725/109

(57) ABSTRACT

Provided is a method and apparatus for accessing service discovery metadata. Advance Internet Protocol Television (AIT) devices may access discovery metadata of different schemes using a generic protocol based on the moving picture experts group (MPEG) Extensible Middleware (MXM). According to the above access scheme, end-user devices, description service provider devices, and IPTV service provider devices may exchange metadata. Subsequent modification and addition of a metadata scheme may be supported.

### TECHNICAL FIELD

The following embodiments relate to a method and apparatus for accessing service discovery metadata.

In an advanced Internet Protocol Television (IPTV) system, disclosed is a generic protocol for accessing service discovery metadata.

### BACKGROUND ART

Service discovery metadata, briefly, discovery metadata enables a user to discover and select an Internet Protocol Television (IPTV) service or content.

The discovery metadata is one of the most important issues in all the IPTV standards.

However, each IPTV standard developed by each standardization group may have a different metadata scheme. Also, in each IPTV standard, predetermined protocols are designed to process, for example, access or update a metadata database of a predetermined scheme.

A purpose of an advanced IPTV standard is to provide general and effective standardized protocols and Application Programming Interfaces (APIs) for fast deployment of IPTV value chain.

However, in a current circumstance, the moving picture experts group (MPEG) IPTV eco-system is expected to process many current and future metadata schemes, for example, an International Telecommunication Union Telecommunication Standardization Sector (ITU-T), an European Telecommunications Standards Institute (ETSI), and Alliance for Telecommunications Industry Solutions (ATIS).

### DISCLOSURE OF INVENTION

### Technical Goals

An aspect of the present invention provides a method and apparatus for accessing discovery metadata of different schemes.

### Technical Solutions

According to an aspect of the present invention, there is provided a discovery metadata accessing method of a requesting device, the method including: generating an access metadata request message indicating information associated with a metadata section desired to be accessed; transmitting the access metadata request message to a description provider device; receiving, from the description provider device, an access metadata response message including description of the metadata section; and obtaining metadata based on the description of the metadata section.

The discovery metadata accessing method of the requesting device may further include signing the access metadata request message.

The discovery metadata accessing method of the requesting device may further include responding to the description provider device using a notification message.

The discovery metadata accessing method of the requesting device may further include generating a metadata scheme request message for accessing the metadata; transmitting the metadata scheme request message to the description provider device; and receiving from the description provider device, a metadata scheme response message indicating whether a scheme of the metadata is accessible.

The metadata scheme request message may include a list of all the metadata schemes supported by the requesting device and a priority attribute for each scheme of the list.

When the scheme of the metadata is accessible, the metadata scheme response message may include an adopted scheme element indicating a metadata scheme selected by the description provider device based on optical match between properties of the requesting device and the description provider device.

When the scheme of the metadata is inaccessible, the metadata scheme response message may include a scheme result element indicating a cause of a failure.

The access metadata request message may include at least one scheme name element indicating a type of the metadata scheme, an encoding element indicating an encoding type to be used for the metadata, a requested section element indicating a group of sections requested in a level of a section hierarchy, and a section condition element transferring identifiers of metadata sections requested in the level of the section hierarchy.

When the metadata request message does not indicate a version value of the metadata section, or when, a version value present in the description provider device of the metadata section requested to the description provider device is greater than a value indicated in the access metadata request message, the metadata response message may include description of the metadata section.

The metadata section may be identified by at least one identifier based on a hierarchical level used to divide the metadata section.

The obtaining may include getting the metadata included in a metadata section element of the access metadata response message, or retrieving the metadata from a position indicated by a metadata Universal Resource Locator (URL) element of the access metadata response message.

According to another aspect of the present invention, there is provided a metadata providing method of a description provider device, the method including: receiving, from a requesting device, an access metadata request message indicating information associated with a metadata section desired to be accessed by the requesting device; generating an access metadata response message including the metadata section; and transmitting the access metadata response message to the requesting message.

The metadata providing method of the description provider device may further include verifying a signature of the access metadata request message.

The metadata providing method of the description provider device may further include receiving a notification message from the requesting device.

The metadata providing method of the description provider device may further include receiving, from the requesting device, a metadata scheme request message for accessing metadata; generating a metadata scheme response message indicating whether a scheme of the metadata is accessible; and transmitting the metadata, scheme response message to the requesting device.

When the scheme of the metadata is accessible, the metadata scheme response message may include an adopted scheme element indicating a metadata scheme selected by the description provider device based on optimal match between properties of the requesting device and the description provider device.

According to still another aspect of the present invention, there is provided a requesting device, including: a control unit to generate an access metadata request message indicating information associated with a metadata section desired to be accessed, and to retrieve metadata based on description, of the metadata section; and an interface unit to transmit, the access metadata request message to a description provider device, and to receive, from the description provider device, an access metadata response message including the description of the metadata section.

### Effect of the Invention

According to embodiments of the present invention, there is provided a method, and apparatus for accessing discovery metadata of a different scheme.

### BRIEF DESCRIPTION OF DRAWINGS

FIG. 1 is a diagram to describe a use method of a protocol to access discovery metadata in an Advance Internet Protocol Television (AIT) value chain according to an embodiment of the present invention;

FIG. 2 is a diagram illustrating an example of sectioning metadata according to an embodiment of the present invention;

FIG. 3 is a diagram illustrating a discovery metadata access protocol according to an embodiment, of the present invention;

FIG. 4 is a block diagram of a requesting device (RD) according to an embodiment of the present invention; and

FIG. 5 is a block diagram illustrating a description provider device (DPD) according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

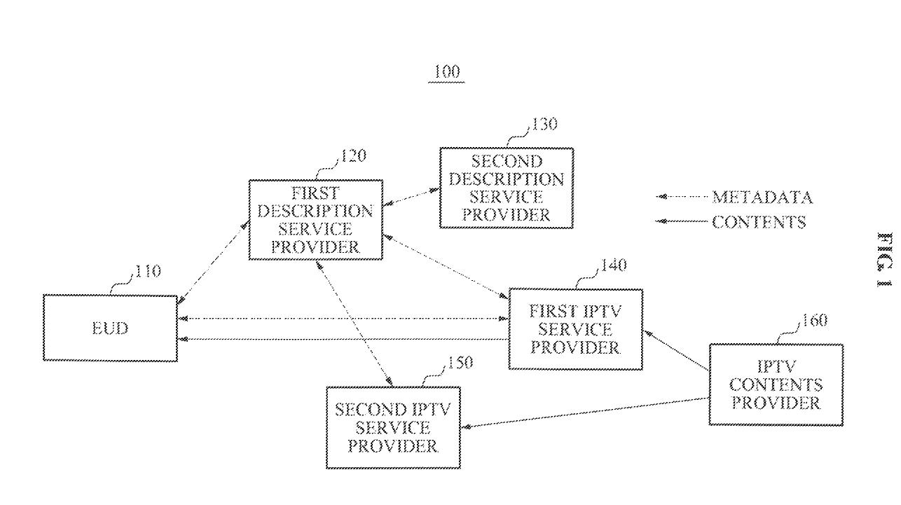

FIG. 1 is a diagram to describe a use method of a protocol to access discovery metadata in an Advance Internet Protocol Television (AIT) value chain according to an embodiment of the present invention.

Proposed is a generic protocol, based on moving picture experts group (MPEG) Extensible Middleware (MXM).

The proposed protocol is to enable AIT devices to access discovery metadata of different schemes.

The proposed protocol enables metadata exchange among end-user devices (EUDs), for example, an EUD 110 of FIG. 1, description service providers devices, for example, a first description service provider 120 and a second description service provider 130, and Internet Protocol Television (IPTV) service provider devices, for example, a first IPTV service provider 140 and a second IPTV service provider 150.

For example, referring to FIG. 1, when the first IPTV service provider 140 or the second IPTV service provider 150 is capable of providing a description service, the BUD 110 may directly request the first IPTV service provider 140 or the second IPTV service provider 150 for metadata.

An access scheme used in the proposed protocol may support subsequent modification of metadata and addition of new metadata.

An IPTV contents provider 160 may provide contents to the first IPTV service provider 140 or the second IPTV service provider 150. The first IPTV service provider 140 or the second IPTV service provider 150 may provide the contents to the EUD 110.

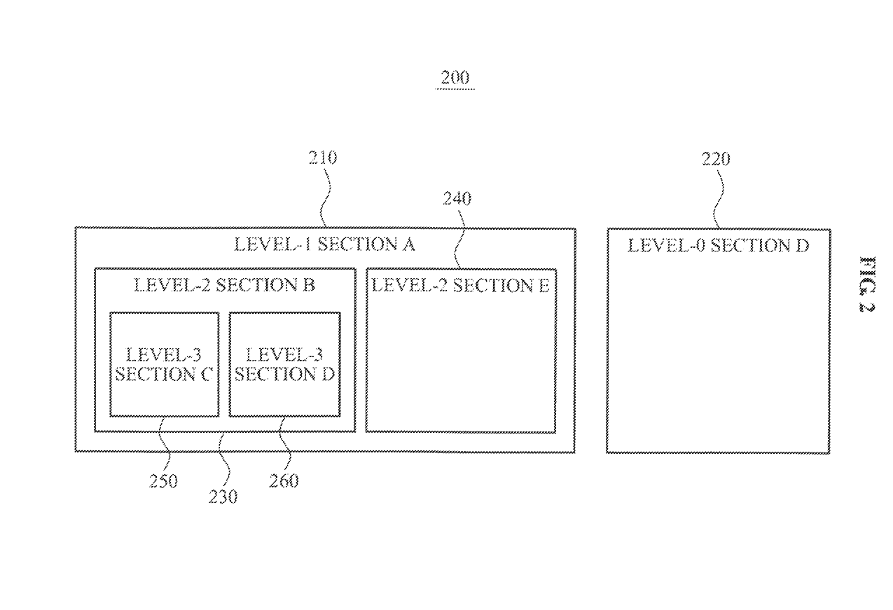

FIG. 2 is a diagram illustrating as a example of sectioning metadata according to an embodiment of the present invention.

Since a variety of providers to provide contents or services consumable in a network are present, a number of databases of discovery metadata or an amount thereof may also be significantly large.

Accordingly, for effective transmission (including update) of metadata, the metadata may be divided into sections or subsections regardless of scheme choices.

Each section may be identified by at least one identifier based on a hierarchical level used to divide a corresponding section.

For example, in FIG. 2, each of rectangular blocks 210, 220, 230, 240, 250, and 260 indicates a single section or a subsection.

An identifier of each section may be unique only within a right upper parent section of a corresponding section.

Referring to FIG. 2, a first metadata section of level-3 of the rectangular block 250 may be identified by three identifiers A, B, and C. In this instance, A denotes a name of a service provider, B denotes a service type of a corresponding service provider, and C denotes a predetermined service provided in a corresponding service type.

A metadata sectioning scheme may be determined according to a predetermined IPTV metadata scheme.

Each section may be associated with an attribute “version” used to update or synchronize metadata between players within an IPTV value chain.

Basically, a user may request only a few sections of metadata, for example, metadata associated with a broadcasting service of a predetermined provider to be accessed or discovered. When a change such as a modification/addition of metadata occurs, a version value of a relevant metadata section may increase whereby the change may be known.

It may be ineffective to design a predetermined protocol for accessing a schema of metadata defined by a predetermined organization. A protocol according to an embodiment of the present invention may support a metadata scheme to be newly defined in the future as well as an existing metadata scheme.

While the protocol according to an embodiment of the present invention uses a general syntax for a protocol message, a sectioning/fragmentation structure of metadata may be expressed using a classification scheme (CS).

The protocol message indicates a section desired to be discovered or be used, and an identifier of a corresponding section may be referred to by the CS. An advantage of the above scheme lies in that as metadata advances, the advanced metadata may be received by modifying or newly generating the CS without a change in the protocol syntax.

Examples of the CS for European Telecommunications Standards Institute (ETSI) IPTV (DVB-IP) and Alliance for Telecommunications Industry Solutions (ATIS) IPTV (HP) will be described by referring to Table 12 through Table 16.

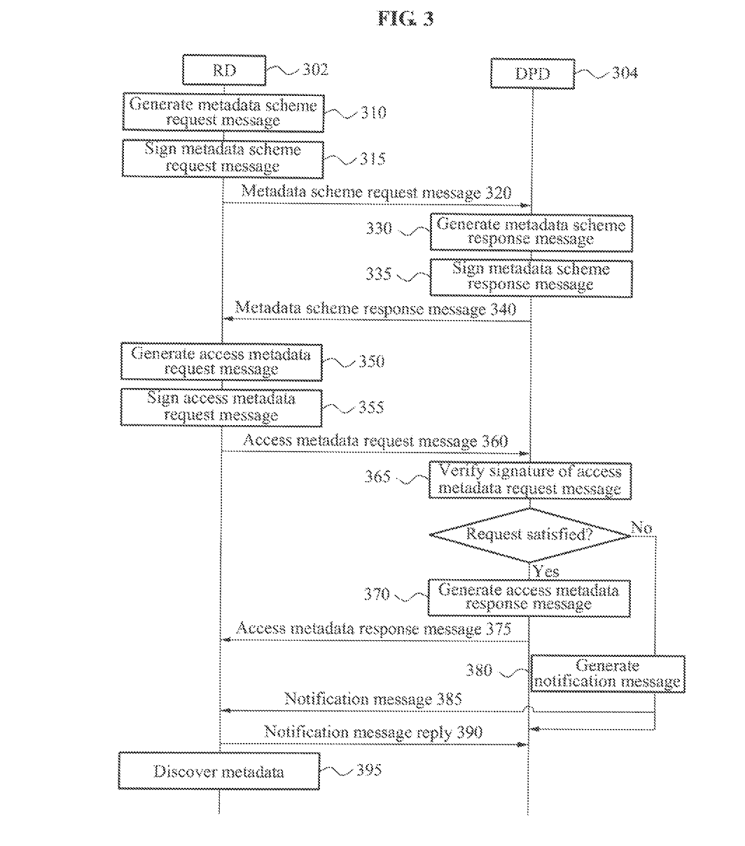

FIG. 3 is a diagram illustrating a discovery metadata protocol according to an embodiment of the present invention.

A protocol for accessing service discovery metadata may be used by a requesting device (RD) that makes a request in order to access metadata present in another description provider device (DPD).

Referring to FIG. 3, an RD 302 may correspond to the EUD 110 of FIG. 1 or a DPD.

The RD 302 and a DPD 304 may be mutually identifiable. When the RD 302 is aware of metadata schemes supported by the DPD 304, the following operations 310 through 340 may be omitted.

in operation 310, the RD 302 may generate a metadata scheme request message, for example, mxm:MetadataSchemeRequest message, for accessing predetermined metadata.

The metadata scheme request message may include a list of all the metadata schemes supported fey the RD 302, for example, an International Telecommunication Union Telecommunication Standardization Sector (ITU-T), ETSL or ATIS. Also, the metadata scheme request message may include a priority attribute for each scheme of the list.

In operation 315, the RD 302 may selectively sign the metadata scheme request message.

In operation 320, the RD 302 may transmit the metadata scheme request message to the DPD 304. The DPD 304 may receive the metadata scheme request message.

In operation 330, the DPD 304 may generate a metadata scheme response message, for example, mxm:MetadataSchemeResponse message. The metadata scheme response message may indicate whether a scheme is accessible, based on a result attribute.

When the scheme is accessible, the scheme response message may include an “AdoptedScheme” element. AdoptedScheme may indicate a metadata scheme that is selected by the DPD 304 based on optimal match between properties of the RD 302 and the DPD 304.

When the scheme is inaccessible, a “SchemeResult” element indicating a cause of a failure may transfer the cause of the failure.

In operation 335, the DPD 304 may selectively sign the metadata scheme response message.

In operation 340, the DPD 304 may transmit the metadata scheme response message to the RD 302.

When the RD 302 has pre-knowledge of a metadata scheme provided by the DPD 304, or when the aforementioned operations 310, 315, 320, 330, 335, and 340 are performed and the RD 302 receives an affirmative reaction from the DPD 304, operations 350 through 395 may be performed.

in operation 350, the RD 302 may generate an access metadata request message, for example, mxm:AccessMetadataRequest message. The access metadata request message may indicate information associated with a metadata section desired to be accessed.

in operation 355, the RD 302 may selectively sign the access metadata request message.

in operation 360, the RD 302 may transmit the access metadata request message to the DPD 304.

In operation 365, the DPD 304 may verify a digital signature when the digital signature is included in the access metadata request message.

When the DPD 304 is capable of satisfying a request of the access metadata request message, operations 370 and 375 may be performed.

In operation 370, the DPD 304 may generate an access metadata response message, for example, mxm:AccessMetadataResponse message.

With respect to each requested section, 1) when a version value is not indicated in the access metadata request message, or 2) when a version value present in a database of the DPD 304 of a section requested to the DPD 304 is greater than a value indicated in the access metadata request message, description of the requested metadata section of the DPD 304 may be included in the access metadata response message. Otherwise, the requested metadata section of the DPD 304 may not be included in the access metadata response message.

When no metadata section is included in the access metadata response message, attribute “Latest” may be set to “true”.

In operation 375, the DPD 304 may transmit the access metadata response message to the RD 302.

When the DPD 304 is incapable of satisfying the request of the access metadata request message, operations 380 and 385 may be performed.

In operation 380, the DPD 304 may generate a notification message, for example, mxm:Acknowledmgent (Ack) message. The notification message may transfer information associated with a cause of a failure.

In operation 385, the DPD 304 may transmit the notification message to the RD 302.

In operation 390, the RD 302 may selectively respond to the DPD 304 using the notification message.

in operation 395, the RD 302 may obtain metadata included in a “MetadataSection” element or may retrieve metadata from a position indicated by a “MetadataURL” element of the access metadata response message.

Table 1 shows definition of an access metadata protocol type, for example, AccessMetadataProtocolType.

```
TABLE 1
<complexType name=“AccessMetadataProtocolType” abstract=“true”>
  <complexContent>
    <extension base=“mxmbp:ProtocolType”/>
  </complexContent>
</complexType>
```

The mxm:AccessMetadataProtocolType complex type defined in Table 1 may extend mxmbp:ProtocolType.

Table 2 shows definition of a response element, for example, mxm:Ack element.

A response message may be used to transfer an error message in the case of a failure, or to inform a success of an operation.

TABLE 2

```
<element name=“Ack” type=“mxm:AckType”/>
<complexType name=“AckType”>
  <complexContent>
    <extension base=“mxm:AccessMetadataProtocolType”>
      <sequence minOccurs=“0”>
        <element ref=“mxmbp:ProtocolResult”/>
      </sequence>
      <attribute name=“Result” type=“boolean” use=“required”/>
    </extension>
  </complexContent>
</complexType>
```

The mxm:Ack message may extend mxmhp:ProtocolResult message by adding the “Result” attribute indicating whether an approved operation is successful.

Table 3 shows definition of a metadata scheme request element, for example, mxm:MetadataSchemeRequest element.

The metadata scheme request, message may be transferred from the RD 302 to the DPD 304 to request permission for access to a portion of discovery metadata present in the database of the DPD 304.

TABLE 3

| <!-- Definition of MetadataSchemeRequest --> | |
|---|---|
| <element | name=“MetadataSchemeRequest” |

```
type=“mxm:MetadataSchemeRequestType”/>
  <complexType name=“MetadataSchemeRequestType”>
    <complexContent>
      <extension base=“mxm:ProtocolRequestType”>
        <sequence>
          <element  name=“MetadataScheme”
type=“mxm:MetadataSchemeType” maxOccurs=“unbounded”/>
        </sequence>
      </extension>
    </complexContent>
  </complexType>
```

Table 4 shows definition of a metadata scheme type, for example, mxm:MetadataSchemeType.

TABLE 4

| <complexType name=“MetadataSchemeType”> | |
|---|---|
| <complexContent> | |
| <extension base=“mxm:ProtocolBaseType”> | |
| <sequence> | |
| <element | name=“SchemeName” |

```
type=“mpeg7:ControlledTermUseType”/>
        </sequence>
        <attribute name=“priority” type=“int” use=“required”/>
      </extension>
    </complexContent>
  </complexType>
```

The mxm:MetadataSchemeType complex type may indicate the metadata scheme defined in CS, for example, as defined in Table 12.

Any term of the CS may be used for a “SchemeName” element of the above type.

Characteristics of all the metadata scheme types may be erased based on a “priority” attribute. The priority attribute may correspond to an integer value that is in inverse proportion to an intended priority. For example, “priority=‘1’” indicates a highest priority.

Similarly, an “EncodingScheme” element may transfer a list of preferred encoding types for the requested metadata. The CS defining available metadata encoding types is disclosed in Table 16.

Table 5 shows definition of the encoding scheme type, for example, mxm:EncodingSchemeType.

TABLE 5

```
<complexType name=“EncodingSchemeType”>
  <complexContent>
    <extension base=“mxmbp:ProtocolBaseType”>
      <sequence>
        <element name=“Encoding”
        type=“mpeg7:ControlledTermUseType”/>
      </sequence>
      <attribute name=“priority” type=“int” use=“required”/>
    </extension>
  </complexContent>
</complexType>
```

Table 6 shows definition of the metadata scheme response element, for example, mxm:MetadataSchemeResponse element.

mxm:MetadataSchemeResponse message may be transferred from the DPD 304 to the RD 302 as a response to mxm:MetadataSchemeRequest.

TABLE 6

| | |
|---|---|
| <element | name=“MetadataSchemeResponse” |

| type=“mxm:MetadataSchemeResponseType”/> | |
|---|---|
| <complexType name=“MetadataSchemeResponseType”> | |
| <complexContent> | |
| <extension base=“mxm:ProtocolResponseType”> | |
| <sequence> | |
| <element | name=“AdoptedSchemeName” |

```
type=“mpeg7:ControlledTermUseType” minOccurs=“0”/>
        </sequence>
      </extension>
    </complexContent>
  </complexType>
```

The response may include verification or rejection of a requested service.

When the response includes the verification, the “Result” attribute may be set to “true”. An “AdoptedSchemeName” element may indicate an “agreed metadata” scheme. Additionally, an “AdoptedEncoding” element may indicate an encoding type of metadata.

When the response includes the rejection, the “Result” attribute may be set to “false”. A “ProtocolResult” element may transfer a cause of a failure. Selectively, a “Signature” element may transfer a digital signature of a message.

Table 7 shows definition of the access metadata request element, for example, mxm:AccessMetadataRequest element.

In order to access the metadata, the RD 302 may transfer the access metadata request message to the DPD 304.

TABLE 7

| <!-- Definition of RequestMetadataRequest --> | |
|---|---|
| <element | name=“RequestMetadataRequest” |
| type=“mxm:RequestMetadataRequestType”/> | |
| <complexType name=“RequestMetadataRequestType”> | |
| <complexContent> | |
| <extension base=“mxm:ProtocolRequestType”> | |
| <sequence> | |
| <element name=“SchemeName” | |
| type=“mpeg7:ControlledTermUseType” minOccurs=“0”/> | |
| <choice> | |
| <element name=“RequestedSection” | |
| type=“mxm:RequestedSectionType”/> | |
| <element name=“RequestedFragmentUri” | |
| type=“anyURI”/> | |
| </choice> | |
| </sequence> | |
| </extension> | |
| </complexContent> | |
| </complexType> | |
| <element | name=“AccessMetadataRequest” |
| type=“mxmamp:AccessMetadataRequestType”/> | |
| <complexType name=“AccessMetadataRequestType”> | |
| <complexContent> | |
| <extension base=“mxmamp:AccessMetadataProtocolType”> | |
| <sequence> | |
| <element name=“SchemeName” | |
| type=“mpeg7:ControlledTermUseType” minOccurs=“0”/> | |
| <element name=“Encoding” | |
| type=“mpeg7:ControlledTermUseType” minOccurs=“0”/> | |
| <element | name=“RequestedSections” |

```
type=“mxmamp:RequestedSectionsType” minOccurs=“0”
maxOccurs=“unbounded”/>
        <element ref=“dsig:Signature” minOccurs=“0”/>
      </sequence>
    </extension>
  </complexContent>
</complexType>
<!-- Definition of RequestedSectionType -->
  <complexType name=“RequestedSectionType”>
    <complexContent>
      <extension base=“mxm:ProtocolBaseType”>
        <sequence>
          <element name=“SectionCondition”
            type=“mxm:SectionConditionType”
            maxOccurs=“unbounded”/>
</sequence>
      </extension>
    </complexContent>
  </complexType>
<!-- Definition of SectionConditionType -->
  <complexType name=“SectionConditionType”>
    <complexContent>
      <extension base=“mxm:ProtocolBaseType”>
        <sequence>
          <element name=“SectionKind”
          type=“mpeg7:ControlledTermUseType”/>
          <element  name=“Identification”
type=“mxm:IdentificationType” minOccurs=“0”/>
        </sequence>
        <attribute name=“Version” type=“int” use=“optional”/>
      </extension>
    </complexContent>
  </complexType>
<complexType name=“ValueType”>
  </complexContent>
    <extension base=“mxmbp:ProtocolBaseType”>
      <choice>
        <element name=“NumericValue” type=“int”/>
        <element name=“TextualValue” type=“string”/>
      </choice>
    </extension>
  </complexContent>
</complexType>
```

The access metadata request, for example, mxm:AccessMetadataRequest message may transfer information as shown in Table 8.

TABLE 8

| Name | Description |
|---|---|
| SchemeName | SchemeName element indicates a type of a metadata scheme to |
| | be used for requested metadata. When the metadata scheme |
| | request message and the metadata scheme response message are |
| | used to determine the metadata scheme, SchemeName element is |
| | not used. However, when the metadata scheme request message |
| | and the metadata scheme response message are not used, and the |
| | RD 302 has pre-knowledge of the metadata scheme supported by |
| | the DPD 304, SchemeName element may be present to indicate a |
| | preferred scheme. |
| Encoding | Encoding element indicates an encoding type to be used for |
| | requested metadata. The use of Encoding element is similar to |
| | the use of SchemeName element. |
| RequestedSections | RequestedSection element indicates a group of sections |
| | requested in a level of a section hierarchy. Requested section |
| | groups to be designated by another instance of RequestedSection |
| | element should not be duplicated. |
| SectionCondition | SectionCondition may transfer identifiers of metadata sections |
| | requested in the level of the section hierarchy. The following |
| | rules are applied: |
| | 1) An identifier of a relatively higher level initially appears |
| | before an identifier of a relatively lower level. Excluding a |
| | lowest level, an identifier of a relatively higher level appears |
| | only once. |
| | 2) A type of a metadata section is indicated by “SectionKind” |
| | element transferring terms defined in discovery CS, for example, |
| | Table 13, Table 14, and Table 15. A predetermined section of |
| | such type is indicated by “NumericValue” or “TextualValue”, for |
| | example, according to the metadata section type defined in Table |
| | 12 through Table 16. For example, when using a CS term for |
| | ETSI IPTV, Sectionkind may be “ServiceProvider” and |
| | TextualValue may be “www.Provider1.com”. |
| | 3) When all the sections of a given type are requested, “Value” |
| | element is not used. |
| | 4) To determine requested section(s), identifiers of relatively |
| | higher levels may be combined with the identifier of the lowest |
| | level. |

Table 9 shows an eXtensible Markup Language (XML) instance. The XML instance of Table 9 indicates that “BroadcastService” type metadata section or segment No. 2 and No. 3 of “Provider1” are requested.

```
TABLE 9
<RequestedSections>
  <SectionCondition>
    <SectionKind href=“ urn:mpeg:ait:2010:DiscoveryCS-NS:2”>
      <mpeg7:Name>ServiceProvider</mpeg7:Name>
    </SectionKind>
    <Value><TextualValue>www.Provider1.com</TextualValue>
    </Value>
  </SectionCondition>
  <SectionCondition>
    <SectionKind href=“ urn:mpeg:ait:2010:DiscoveryCS-NS:2.1”>
      <mpeg7:Name>BroadcastService</mpeg7:Name>
    </SectionKind>
    <Value><NumericValue>2</NumericValue></Value>
  </SectionCondition>
  <SectionCondition>
    <SectionKind href=“ urn:mpeg:ait:2010:DiscoveryCS-NS:2.1”>
      <mpeg7:Name>BroadcastService</mpeg7:Name>
    </SectionKind>
    <Value><NumericValue>3</NumericValue></Value>
  </SectionCondition>
<RequestedSections>
```

In Table 9, “Version” corresponds to an attribute used to indicate a current version value of a requested section. “dsig:Signature)” denotes a digital signature of a message, and “dsig:Signature” corresponds to an optional value.

Table 10 shows definition of the access metadata response element, for example, a schema of mxm:AccessMetadataResponse element. The definition may be, for example, a schema of the access metadata response message.

TABLE 10

| | |
|---|---|
| <element | name=“AccessMetadataResponse” |

```
type=“mxmaitp:AccessMetadataResponseType”/>
<complexType name=“AccessMetadataResponseType”>
  <complexContent>
    <extension base=“mxm:AccessMetadataProtocolType”>
      <sequence>
        <element  name=“RepliedSection”
type=“mxm:RepliedSectionType” minOccurs=“0”
maxOccurs=“unbounded”/>
        <element ref=“dsig:Signature” minOccurs=“0”/>
      </sequence>
      <attribute name=“Latest” type=“boolean” use=“optional”/>
    </extension>
  </complexContent>
</complexType>
<complexType name=“RepliedSectionType”>
  <complexContent>
    <extension base=“mxmbp:ProtocolBaseType”>
      <sequence>
        <element  name=“SectionCondition”
type=“mxm:SectionConditionType” maxOccurs=“unbounded”/>
        <choice>
          <element name=“MetadataSection”>
            <complexType>
              <sequence>
                <any namespace=“##any” processContents=“skip”/>
              </sequence>
            </complexType>
          </element>
          <element name=“MetadataURL” type=“anyURI”/>
        </choice>
      </sequence>
    </extension>
  </complexContent>
</complexType>
```

The access metadata response message may be transmitted as a reply to the access metadata request.

The access metadata response message may be used by the DPD 304 to transfer information disclosed in Table 11.

TABLE 11

| Name | Description |
|---|---|
| RepliedSection | RepliedSection element corresponds to an element of |
| | transferring a predetermined metadata section |
| | identified by SectionCondition element. In this |
| | instance, an identifier of each level appears only |
| | once. |
| Latest | When there is no need to respond to or update all the |
| | requested metadata sections, the Latest attribute may |
| | be set to true and any metadata section is not |
| | transmitted. |
| MetadataSection | MetadataSection element includes a transferred |
| | metadata section in a reply message. |
| MetadataURL | MetadataURL element indicates a Universal Resource |
| | Locator (URL) to obtain a requested metadata section. |
| | As shown in syntax, a single element, for example, |
| | only MetadataSection or MetadataURL is used to |
| | transfer the metadata section. |
| dsig:Signature | dsig:Signature element denotes a digital signature of a |
| | message. dsig:Signature element corresponds to an |
| | optional value. |

Table 12 shows the CS for a list of service discovery metadata schemes.

TABLE 12

```
<ClassificationScheme uri=
“urn:mpeg:ait:2010:DiscoveryMetadataSchemesCS-NS” >
  <Term termed=“1”>
    <Name xml:lang=“en”>ETSI-Service-Discovery</Name>
    <Definition xml:lang=“en”> Indicates the metadata scheme of
ETSI IPTV for service discovery.
    </Definition>
  </Term>
  <Term termed=“2”>
    <Name xml:lang=“en”>ATIS-Service-Discovery</Name>
    <Definition xml:lang=“en”> Indicates the metadata scheme of
ATIS IPTV for service discovery.
    </Definition>
  </Term>
  <Term termed=“3”>
    <Name xml:lang=“en”>ITUT-Service-Discovery</Name>
    <Definition xml:lang=“en”> Indicates the metadata scheme of
ITU-T IPTV for service discovery.
    </Definition>
  </Term>
</ClassificationScheme>
```

Table 13 shows the CS for service discovery metadata sections of ETSI.

```
TABLE 13
<ClassficationScheme uri=“urn:mpeg:ait:2010:ETSIDiscoveryCS-NS”>
  <Term termId=“1”>
    <Name xml:lang=“en”>ServiceProviderDiscovery</Name>
    <Definition xml:lang=“en”> Indicates the metadata for service
provider discovery information (payload ID 0x01). Metadata of this
type could be divided into sections, identified by numeric values.
    </Definition>
  </Term>
  <Term termId=“2”>
    <Name xml:lang=“en”>ServiceProvider</Name>
    <Definition xml:lang=“en”> Indicates all service discovery
metadata of an IPTV Service Provider. Different service providers
are differentiated by their domain names (i.e. textual values).
    </Definition>
    <Term termId=“2.1”>
      <Name xml:lang=“en”>BroadcastService</Name>
      <Definition xml:lang=“en”> Indicates metadata for broadcast
service discovery of an IPTV Service Provider (payload ID 0x02).
Metadata of this type could be divided into sections, identified
by numeric values.
      </Definition>
    </Term>
    <Term termId=“2.2”>
      <Name xml:lang=“en”>CoDService</Name>
      <Definition xml:lang=“en”> Indicates metadata for Content-on-
Demand service discovery of an IPTV Service Provider (payload
ID 0x03). Metadata of this type could be divided into sections,
identified by numeric values.
      </Definition>
    </Term>
    <Term termId=“2.3”>
      <Name xml:lang=“en”>ServicesFromOtherSP</Name>
      <Definition xml:lang=“en”> Indicates metadata for referenced
service discovery at an IPTV Service Provider (payload ID 0x04).
Metadata of this type could be divided into sections, identified by
numeric values.
      </Definition>
    </Term>
    <Term termId=“2.4”>
      <Name xml:lang=“en”>PackageService</Name>
      <Definition xml:lang=“en”> Indicates metadata for package
service discovery of an IPTV Service Provider (payload ID 0x05).
Metadata of this type could be divided into sections, identified by
numeric values.
      </Definition>
    </Term>
    <Term termId=“2.5”>
      <Name xml:lang=“en”>BCGService</Name>
      <Definition xml:lang=“en”> Indicates metadata for BCG
(Broadband Content Guide) service discovery of an IPTV Service Provider
(payload ID 0x06). Metadata of this type could be divided into sections,
identified by numeric values. Note: BCG metadata will have its own
classification scheme.
      </Definition>
    </Term>
  </Term>
</ClassificationScheme>
```

Table 14 shows CS for service discovery metadata sections of ATIS.

```
TABLE 14
<ClassificationScheme uri=“urn:mpeg:ait:2010:ATISDiscoveryCS-NS”>
  <Term termId=“1”>
    <Name xml:lang=“en”>ServiceProviderInfo</Name>
    <Definition  xml:lang=“en”>Indicates  a  metadata
record  of  ATIS  IIF ServiceProviderInfoType which provides
information about different IPTV service providers</Definition>
  </Term>
  <Term termId=“2”>
    <Name xml:lang=“en”>ServiceProvider</Name>
    <Definition xml:lang=“en”>Indicates all service discovery
metadata of an IPTV Service Provider</Definition>
  <Term termId=“2.1”>
    <Name xml:lang=“en”>ProvisioningInfo</Name>
    <Definition  xml:lang=“en”>Indicates  a  metadata  record
of  ATIS  IIF ProvisioningInfoType which provides provisioning
information from an IPTV service provider</Definition>
  </Term>
  <Term termId=“2.2”>
    <Name xml:lang=“en”>Master SI Table</Name>
    <Definition  xml:lang=“en”>  Indicates  a  metadata  record
of  ATIS  IIF MasterSiTableType which is a list of virtual channel map
tables of a given service provider.</Definition>
  </Term>
  <Term termId=“2.3”>
    <Name xml:lang=“en”>Virtual Channel Map</Name>
    <Definition  xml:lang=“en”>Indicates  a  metadata  record
of  ATIS  IIF VirtualChannelMapType which is a list of virtual
channels. Each record is identified by a textual string representing
the URI of the record</Definition>
  </Term>
  <Term termId=“2.4”>
    <Name xml:lang=“en”>Virtual Channel Description</Name>
    <Definition  xml:lang=“en”>  Indicates  a  metadata  record
of  ATIS  IIF VirtualChannelDescriptionType which is a description
of virtual channels. Each record is identified by a textual string
representing the URI of the record</Definition>
  </Term>
  <Term termId=“2.5”>
    <Name xml:lang=“en”>Source</Name>
    <Definition xml:lang=“en”> Indicates a metadata record of ATIS
IIF SourceType which shows acquisition information for virtual channels.
Each record is identified by a textual string representing the URI of the
record </Definition>
  </Term>
  <Term termId=“2.6”>
    <Name xml:lang=“en”>EPGInfo</Name>
    <Definition xml:lang=“en”> Indicates all metadata for
    electronic program guide.
Note: EPG metadata will have its own classification scheme. </Definition>
  </Term>
</ClassificationScheme>
```

Table 15 shows CS for service discovery metadata, sections of ITU-T.

```
TABLE 15
<ClassificationScheme uri=“urn:mpeg:ait:2010:ITUTDiscoveryCS-NS”>
  <Term termed=“1”>
    <Name xml:lang=“en”>ITUT</Name>
    <Definition xml:lang=“en”> This CS will be described once
the schema of ITU-T IPTV service discovery is completed.
    </Definition>
  </Term>
</ClassificationScheme>
```

Table 16 shows CS for metadata encoding types.

TABLE 16

```
<ClassificationScheme uri=
“urn:mpeg:ait:2010:DiscoveryMetadataSchemesCS-NS” >
  <Term termed=“1”>
    <Name xml:lang=“en”>ETSI-Service-Discovery</Name>
    <Definition xml:lang=“en”> Indicates the metadata scheme of
ETSI IPTV for service discovery.
    </Definition>
  </Term>
  <Term termed=“2”>
    <Name xml:lang=“en”>ATIS-Service-Discovery</Name>
    <Definition xml:lang=“en”> Indicates the metadata scheme of
ATIS IPTV for service discovery.
    </Definition>
  </Term>
  <Term termed=“3”>
    <Name xml:lang=“en”>ITUT-Service-Discovery</Name>
    <Definition xml:lang=“en”> Indicates the metadata scheme of
ITU-T IPTV for service discovery.
    </Definition>
  </Term>
</ClassificationScheme>
```

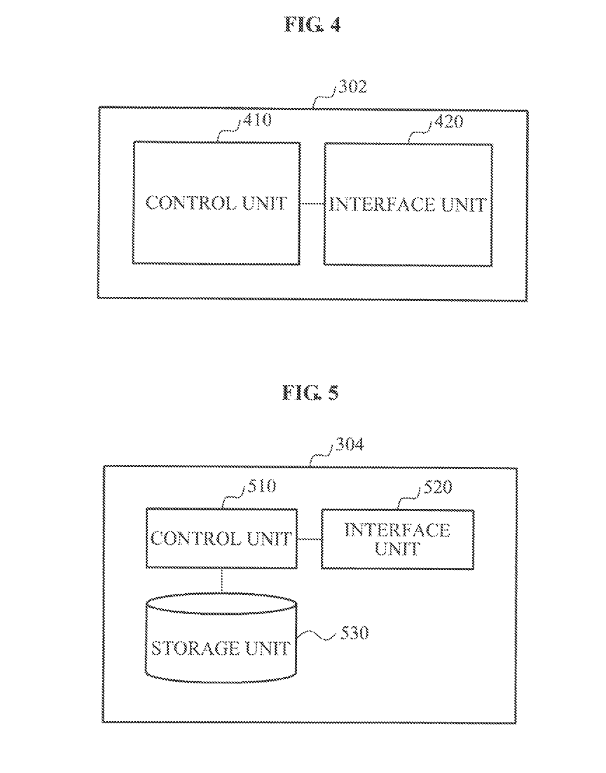

FIG. 4 is a block diagram of the RD 302 of FIG. 3 according to an embodiment of the present invention.

Referring to FIG. 4, the RD 302 may include a control unit 410 and an interface unit 420.

The control unit 410 may generate a message to be transmitted by the RD 302, and may process a message received by the RD 302. For example, the control unit 410 may process operations 310, 315, 350, 355, and 395.

The interface unit 420 may transmit, the generated message to the DPD 304, and receive a message from the DPD 304. For example, the interface unit 420 may transmit or receive a message in operations 320, 340, 360, 375, 385, and 390.

The technical descriptions according to an embodiment of the present invention described above with reference to FIG. 1 through FIG. 3 may be applicable as is to the present embodiment. Accordingly, further detailed description will be omitted here.

FIG. 5 is a block diagram illustrating the DPD 304 of FIG. 3 according to an embodiment of the present invention.

Referring to FIG. 5, the DPD 304 may include a control unit 510, an interface unit 520, and a storage unit 530.

The control unit 510 may generate a message to be transmitted by the DPD 304, and process a message received by the DPD 304. For example, the control unit 510 may process operations 330, 335, 365, 370, and 380.

The interface unit 320 may transmit the generated message to the RD 302, and may receive the message from the RD 302. For example, the interface unit 520 may transmit or receive the message in operations 320, 340, 360, 375, 385, and 390.

The storage unit 530 may provide, to the control unit 510, data required for processing of the control unit 510. For example, the storage unit 530 may provide a metadata scheme and the like to the storage unit 530.

The technical descriptions according to an embodiment of the present invention described above with reference to FIG. 1 through FIG. 4 may be applicable as is to the present embodiment. Accordingly further detailed description will be omitted here.

The above-described exemplary embodiments of the present invention may be recorded in computer-readable media including program instructions to implement various operations embodied by a computer. The media may also include, alone or in combination with the program instructions, data files, data, structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary-embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A discovery metadata accessing method of a requesting device, the method comprising:
generating an access metadata request message indicating information associated with a metadata section desired to be accessed;
transmitting the access metadata request message to a description provider device;
receiving, from the description provider device, an access metadata response message comprising description of the metadata section; and
obtaining metadata based on the description of the metadata section.

2. The method of claim 1, further comprising
signing the access metadata request message.

3. The method of claim 1, further comprising:
responding to the description provider device using a notification message.

4. The method of claim 1, further comprising:
generating a metadata scheme request message for accessing the metadata;
transmitting the metadata scheme request message to the description provider device; and
receiving from the description provider device, a metadata scheme response message indicating whether a scheme of the metadata is accessible.

5. The method of claim 4, wherein the metadata scheme request message comprises a list of all the metadata schemes supported by the requesting device and a priority attribute for each scheme of the list.

6. The method of claim 4, wherein when the scheme of the metadata is accessible, the metadata scheme response message comprises an adopted scheme element indicating a metadata scheme selected by the description provider device based on optical match between properties of the requesting device and the description provider device.

7. The method of claim 4, wherein when the scheme of the metadata is inaccessible, the metadata scheme response message comprises a scheme result element indicating a cause of a failure.

8. The method of claim 4, wherein the access metadata request message comprises at least one of a scheme name element indicating a type of the metadata scheme, an encoding element indicating an encoding type to be used for the metadata, a requested section element indicating a group of sections requested in a level of a section hierarchy, and a section condition element transferring identifiers of metadata sections requested in the level of the section hierarchy.

9. The method of claim 1, wherein when the metadata request message does not indicate a version value of the metadata section, or when a version value present in the description provider device of the metadata section requested to the description provider device is greater than a value indicated in the access metadata request message, the metadata response message comprises description of the metadata section.

10. The method of claim 1, wherein the metadata section is identified by at least one identifier based on a hierarchical level used to divide the metadata section.

11. The method of claim 1, wherein the obtaining comprises getting the metadata included in a metadata section element of the access metadata response message, or retrieving the metadata from a position indicated by a metadata Universal Resource Locator (URL) element of the access metadata response message.

12. A metadata providing method of a description provider device, the method comprising:
receiving, from a requesting device, an access metadata request message indicating information associated with a metadata section desired to be accessed by the requesting device;
generating an access metadata response message comprising the metadata section; and
transmitting the access metadata response message to the requesting message.

13. The method of claim 12, further comprising:
verifying a signature of the access metadata request message.

14. The method of claim 12, further comprising:
receiving a notification message from the requesting device.

15. The method of claim 12, further comprising:
receiving, from the requesting device, a metadata scheme request message for accessing metadata;
generating a metadata scheme response message indicating whether a scheme js of the metadata is accessible; and
transmitting the metadata scheme response message to the requesting device.

16. The method of claim 15, wherein when the scheme of the metadata is accessible, the metadata scheme response message comprises an adopted scheme element indicating a metadata scheme selected by the description provider device based on optical match between properties of the requesting device and the description provider device.

17. The method of claim 15, wherein when the scheme of the metadata is inaccessible, the metadata scheme response message comprises a scheme result element indicating a cause of a failure.

18. The method of claim 12, wherein when the metadata request message does not indicate a version value of the metadata section, or when a version value present in the description provider device of the metadata section requested to the description provider device is greater than a value indicated in the access metadata request message, the metadata response message comprises description of the metadata section.

19. The method of claim 10, wherein the metadata section is identified by at least one identifier based on a hierarchical level used to divide the metadata section.

20. A requesting device, comprising:
a control unit to generate an access metadata request message indicating information associated with a metadata section desired to be accessed, and to discover metadata based on description of the metadata section; and
an interface unit to transmit the access metadata request message to a description provider device, and to receive, from the description provider device, an access metadata response message comprising the description of the metadata section.
